(19) United States
(12) Patent Application Publication
(10) Pub. No.: US 2013/0185671 A1
(43) Pub. Date: Jul. 18, 2013

(54) ELECTRONIC DEVICE AND METHOD FOR UNLOCKING THE ELECTRONIC DEVICE

(71) Applicant: HSING-CHUN HSIEH, Shindian (TW)

(72) Inventor: HSING-CHUN HSIEH, Shindian (TW)

(73) Assignee: FIH (HONG KONG) LIMITED, Kowloon (HK)

(21) Appl. No.: 13/569,123

(22) Filed: Aug. 7, 2012

(30) Foreign Application Priority Data
Jan. 13, 2012 (TW) 101101468

(51) Int. Cl. G06F 3/041; G06F 3/048

(52) U.S. Cl. 715/781

(57) ABSTRACT

A method for unlocking an electronic device, a first touch point and a second touch point are received on an obverse touch panel and a reverse touch panel of the electronic device. The method determines a first area and a second area based on the first touch point, the second touch point and a preset size, records a duration time of an overlapping status of the first area and the second area, and unlocks the electronic device when the duration time reaches a preset value.

### BACKGROUND

1. Technical Field

Embodiments of the present disclosure relate to electronic device unlocking technology, and particularly to a dual touch-panel electronic device and method for unlocking the electronic device using the dual touch-panels.

2. Description of Related Art

Electronic devices (e.g., a mobile phone) may be unlocked using a slide operation on a touch panel of the electronic devices. However, some electronic devices have two touch panels (i.e., dual touch panels), where the slide operation is performed only on a single touch panel to unlock the electronic device. Therefore, a new method for unlocking an electronic device using dual touch panels is desired.

### BRIEF DESCRIPTION OF THE DRAWINGS

FIG. 1 is a schematic diagram of one embodiment of an electronic device including an unlocking system.

FIG. 2 is a schematic diagram of function modules of the unlocking system included in the electronic device.

FIG. 3 is a flowchart of one embodiment of a method for unlocking the electronic device.

FIG. 4 is a schematic diagram of an example of detecting a first touch point on an obverse touch panel and a second touch point on a reverse touch panel of the electronic device.

FIG. 5 is a schematic diagram of an example of a first area and a second area determined by the first touch point and the second touch point.

FIG. 6 is a schematic diagram of an example of slide operations on the obverse touch panel and the reverse touch panel for unlocking the electronic device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

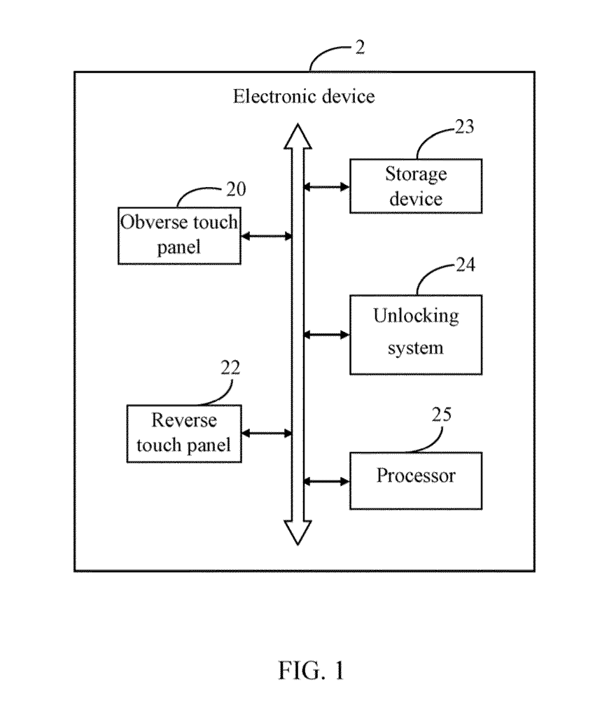

FIG. 1 is a schematic diagram of one embodiment of an electronic device 2 including an unlocking system 24. The electronic device 2 further includes an obverse touch panel 20, a reverse touch panel 22, a storage device 23, and at least one processor 25. The electronic device 2 may be a smart phone or a personal digital assistant (PDA). FIG. 1 illustrates only one example of the electronic device 2 that may include more or fewer components than illustrated, or have a different configuration of the various components in other embodiments.

The obverse touch panel 20 and the reverse touch panel 22 may be resistive touch panels or capacitive touch panels, such as multi-touch panels. The storage device 23 may be a non-volatile computer storage that can be electrically erased and reprogrammed, such as a flash memory card.

The unlocking system 24 provides a unlocking mechanism using the obverse touch panel 20 and the reverse touch panel 22. In one embodiment, the unlocking system 24 may include computerized instructions in the form of one or more programs that are executed by the at least one processor 25 and stored in the storage device 23 (or memory). A detailed description of the unlocking system 24 will be given in the following paragraphs.

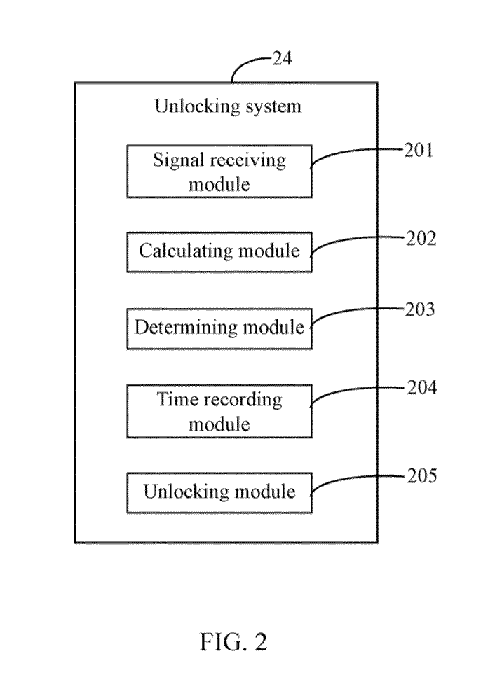

FIG. 2 is a block diagram of function modules of the unlocking system 24 included in the electronic device 2. In one embodiment, the unlocking system 24 may include one or more modules, for example, a signal receiving module 201, a calculating module 202, a determining module 203, a time recording module 204, and an unlocking module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

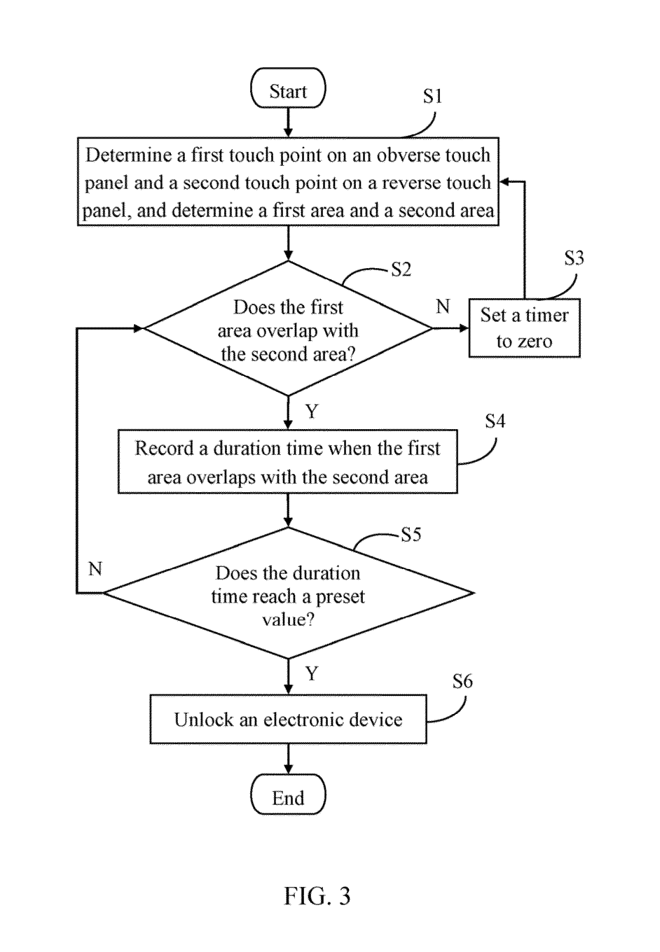

FIG. 3 is a flowchart of one embodiment of a method for unlocking the electronic device 2. Depending on the embodiment, additional steps may be added, others removed, and the ordering of the steps may be changed.

In step 51, the signal receiving module 201 determines a first touch point on the obverse touch panel 20 and a second touch point on the reverse touch panel 22 when slide operations of the fingers of a user are detected on the obverse touch panel 20 and on the reverse touch panel 22, and obtains coordinates of the first touch point and the second touch point on the panels 20, 22. In one embodiment, the slide operations include a first slide operation on the obverse touch panel 20 and a second slide operation on the reverse touch panel 22. The slide operation is a continuous movement of a finger between two points of the touch panel (e.g., the obverse touch panel 20 or the reverse touch panel 22). Then, the calculating module 202 determines a first area according to the first touch point and a preset size, and determines a second area according to the second touch point and the preset size. A first center of the first area is determined by the coordinates of the first touch point, and a second center of the second area is determined by the coordinates of the second touch point.

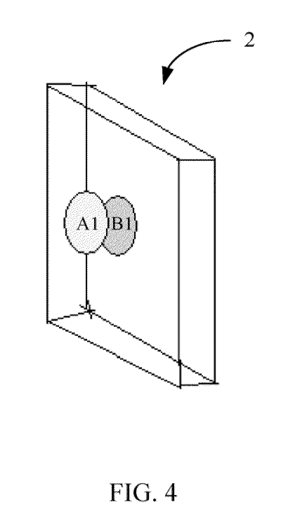

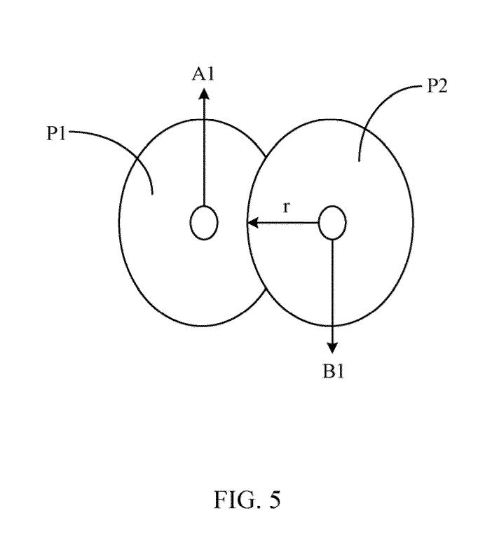

For example, as shown in FIG. 4, suppose that point “A1” represents the first touch point on the obverse touch panel 20, point “B1” represents the second touch point on the reverse touch panel 22. In one embodiment, as shown in FIG. 5, a first circle “P1” is determined to be the first area, a second circle “P2” is determined to be the second area. A center of the first circle “P1” is the point “A1”, a center of the second circle “P2” is the point “B1”, “r” represents a radius of the first circle “P1” and the second circle “P2”. That is, “r” represents the preset size of the first area and the second area (e.g., r=10 pixels).

In one embodiment, radius of the first circle “P1” and the second circle “P2” is determined according to a resolution or a sensitivity of the obverse touch panel 20 or the reverse touch panel 22. In some embodiments, the resolution and the sensitivity of the obverse touch panel 20 and the reverse touch panel 22 are the same.

In other embodiments, the first area and the second area may be determined using other methods. For example, the first area is determined as a first rectangle having a preset width and a preset height, the second area is determined as a second rectangle having the same width and height, where a center of the first rectangle is the point “A1”, and a center of the second rectangle is the point “B1”.

In step S2, the determining module 203 determines whether the first area overlaps with the second area. As shown in FIG. 5, if the first area “P1” and the second area “P2” have at least one intersection point, the determining module 203 determines that the first area “P1” overlaps with the second area “P2”.

In step S3, if the first area does not overlap with the second area, the time recording module 204 set a timer (e.g., a hardware timer or a software timer) of the electronic device 2 to zero, then the procedure returns to step S1.

In step S4, if the first area overlaps with the second area, the time recording module 204 records a duration time “T” of an overlapping status of the first area and the second area using the timer of the electronic device 2. The overlapping status refers to a status that the first area overlaps with the second area. A position of the first area and a position of the second area are movable in response to the slide operations of the finger of the user on the obverse touch panel 20 and the reverse touch panel 22.

In step S5, the determining module 203 determines whether the duration time “T” reaches a preset value “t0”. If the duration time “T” reaches a preset value “t0” (e.g., T≧t0), the procedure goes to step S6. If the duration time “T” does not reach the preset value “t0” (e.g., T,<t0), the procedure returns to step S2. In one embodiment, the preset value “t0” is equal to two seconds.

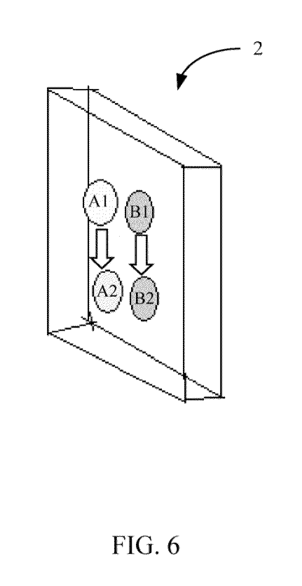

In step S6, the unlocking module 205 unlocks the electronic device 2. An example of the slide operations on the obverse touch panel 20 and on the reverse touch panel 22 for unlocking the electronic device 2 is shown in FIG. 6.

As shown in FIG. 6, the user touches the obverse touch panel 20 and the reverse touch panel 22 at the same time. The signal receiving module 201 obtains a first touch point “A1” on the obverse touch panel 20 and a second touch point “B1” on the reverse touch panel 22, and the first area determined by the first touch point “A1” overlaps with the second area determined by the second touch point “B1”. When the user performs slide operations on the obverse touch panel 20 and on the reverse touch panel 22 for a preset time length until the duration time “T” of the slide operation reaches the preset value “t0”, the first area overlaps with the second area during the slide operations. Then, the first touch point is moved from “A1” to “A2”, and the second touch point is moved from “B1” to “B2”, the unlocking module 205 unlocks the electronic device 2. If the first area does not overlap with the second area during the slide operation, the procedure returns to step S1 to restart the unlocking operation.

In other embodiments, the unlocking method of the present application can be used in the electronic device 2 which has only a single touch panel. For example, the single touch panel may be separated into two areas, such as a top area and a bottom area. Then, the unlocking system 24 may unlock the electronic device 2 by detecting a first touch point on the top area and a second touch point on the bottom area of the single touch panel. That is to say, the top area of the single touch panel is the equivalent with the obverse touch panel 20, and the bottom area of the single touch panel is the equivalent with the reverse touch panel 22.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for unlocking an electronic device comprising a processor, an obverse touch panel, and a reverse touch panel, the method comprising:
determining a first touch point on the obverse touch panel and a second touch point on the reverse touch panel of the electronic device in response to receiving a first slide operation on the obverse touch panel and a second slide operation on the reverse touch panel;
determining a first area based on the first touch point and a preset size, and determining a second area based on the second touch point and the preset size;
recording a duration time of an overlapping status of the first area and the second area; and
unlocking the electronic device when the duration time reaches a preset value.

2. The method according to claim 1, wherein the first area is determined as a first circle having a preset radius, and the second area is determined as a second circle having the preset radius, a center of the first circle being the first touch point, and a center of the second circle being the second touch point.

3. The method according to claim 2, wherein the preset radius is determined according to a resolution or a sensitivity of the obverse touch panel or the reverse touch panel.

4. The method according to claim 1, wherein the first area is determined as a first rectangle having a preset width and a preset height, and the second area is determined as a second rectangle having the preset width and the preset height, a center of the first rectangle being the first touch point, and a center of the second rectangle being the second touch point.

5. The method according to claim 1, wherein the first area overlaps with the second area upon the condition that the first area and the second area have at least one intersection point.

6. An electronic device, comprising:
an obverse touch panel;
a reverse touch panel;
a storage device;
at least one processor; and
one or more modules that are stored in the storage device and are executed by the at least one processor, the one or more modules comprising:
a signal receiving module that determines a first touch point on the obverse touch panel and a second touch point on the reverse touch panel in response to receiving a first slide operation on the obverse touch panel and a second slide operation on the reverse touch panel;
a calculating module that determines a first area based on the first touch point and a preset size, and determines a second area based on the second touch point and the preset size;
a time recording module that records a duration time of an overlapping status of the first area and the second area; and
an unlocking module that unlocks the electronic device when the duration time reaches a preset value.

7. The electronic device according to claim 6, wherein the first area is determined as a first circle having a preset radius, and the second area is determined as a second circle having the preset radius, a center of the first circle being the first touch point, a center of the second circle being the second touch point.

8. The electronic device according to claim 7, wherein the preset radius is determined according to a resolution or a sensitivity of the obverse touch panel or the reverse touch panel.

9. The electronic device according to claim 6, wherein the first area is determined as a first rectangle having a preset width and a preset height, and the second area is determined as a second rectangle having the preset width and the preset height, a center of the first rectangle being the first touch point, and a center of the second rectangle being the second touch point.

10. The electronic device according to claim 6, wherein the first area overlaps with the second area upon the condition that the first area and the second area have at least one intersection point.

11. A non-transitory storage medium having stored thereon instructions that, when executed by a processor of an electronic device, causes the electronic device to perform a method for unlocking the electronic device, the method comprising:
determining a first touch point on an obverse touch panel and a second touch point on a reverse touch panel of the electronic device in response to receiving a first slide operation on the obverse touch panel and a second slide operation on the reverse touch panel;
determining a first area based on the first touch point and a preset size, and determining a second area based on the second touch point and the preset size;
recording a duration time of an overlapping status of the first area and the second area; and
unlocking the electronic device when the duration time reaches a preset value.

12. The non-transitory storage medium according to claim 11, wherein the first area is determined as a first circle having a preset radius, and the second area is determined as a second circle having the preset radius, a center of the first circle being the first touch point, and a center of the second circle being the second touch point.

13. The non-transitory storage medium according to claim 12, wherein the preset radius is determined according to a resolution or a sensitivity of the obverse touch panel or the reverse touch panel.

14. The non-transitory storage medium according to claim 11, wherein the first area is determined as a first rectangle having a preset width and a preset height, and the second area is determined as a second rectangle having the preset width and the preset height, a center of the first rectangle being the first touch point, a center of the second rectangle being the second touch point.

15. The non-transitory storage medium according to claim 11, wherein the first area overlaps with the second area upon the condition that the first area and the second area have at least one intersection point.

16. The non-transitory storage medium according to claim 11, wherein the medium is selected from the group consisting of a hard disk drive, a compact disc, a digital video disc, and a tape drive.
